(19) United States
(12) Patent Application Publication
(10) Pub. No.: US 2001/0032252 A1
(43) Pub. Date: Oct. 18, 2001

(54) System and method for linking online resources to print media and authoring tool for same

(76) Inventors: Robert T. Durst JR., Fort Myers, FL (US); Kevin D. Hunter, Fort Myers, FL (US); David James Stein, Fort Myers, FL (US)

Correspondence Address: Anthony R. Barkume, Esq.,, Greenberg Traurig, LLP,, 200 Park Avenue, New York, NY, 10166, US

(21) Appl. No.: 09/726,086

(22) Filed: Nov. 29, 2000

Related U.S. Application Data
(60) Provisional application No. 60/167,802, filed on Nov. 29, 1999.

(51) Int. Cl. G06F 15/16

(52) U.S. Cl. 709/218; 709/219; 707/500

(57) ABSTRACT

A network-based system and method permit a publisher to generate and encode content to be readily accessed by codes or indicia, such as bar codes, and which may be associated with advertising related to the content via the codes. The system supports composer, reader, discovery, and static web page interfaces for permitting users to act as publishers, readers, or browsers, using the codes for efficient and rapid access of content.

### CROSS-REFERENCE TO RELATED APPLICATION

This application is based on and claims priority of co-pending application Ser. No. 60/167,802, filed Nov. 29, 1999, which is incorporated by reference herein.

### FIELD OF THE INVENTION

The present invention relates to the linking of print media such as brochures, flyers, advertisements and the like, to online resources such as web sites and/or other resources accessible over a network such as the Internet. In particular, the present invention allows placement of and linkage to on-line content such as advertisements with respect to conventional printed media.

### BACKGROUND OF THE INVENTION

Data referencing and access methods are known for accessing content on networks. For example, entry of a string of characters, called a Universal Resource Locator (URL) address, into an input field of a browser causes the browser to interface with one or more web servers on the Internet to access a website corresponding to the URL.

One convenient method of accessing data is the use of bar codes, for example, in supermarkets to access a network storing price data. However, heretofore, the use of bar codes has been limited to specialized systems, and have not proliferated to consumers.

A need exists for a system which permits consumers to utilized the advantages of bar codes to access specific content on a network, for example, the Internet.

In addition, content is typically generated and placed/stored on the Internet using cumbersome graphics and HTML drafting software, with indexing such content being arbitrary according to each content creator. Accordingly, generation and subsequent access of Internet-based content has been difficult. Furthermore, relating content to advertising has been haphazard and arbitrary, since a given webpage of content may pertain to more than one type of product or service.

A need exists for a system for readily generating and accessing content, with such content readily associated with related advertising.

### SUMMARY OF THE INVENTION

A network-based system and method permit a publisher to generate and encode content to be readily accessed by codes or indicia, such as bar codes, and which may be associated with advertising related to the content via the codes. The system supports composer, reader, discovery, and static web page interfaces for permitting users to act as publishers, readers, or browsers, using the codes for efficient and rapid access of content.

In one embodiment, the system includes a publisher interface which responds to publisher inputs for generating a graphic, including a bar code, associated with a web-based document including the content, and for outputting the graphic with the bar code onto a physical document. A user interface is provided for receiving, from the user, the graphic with the bar code on the physical document to access the corresponding content selected by the user. A web server responds to the inputted graphic with the bar code, for providing the web-based document including the selected content. A content storage device may be provided for storing the web-based document generated by a publisher associated with the graphic and retrievable by the web server.

The composer interface may be used to respond to selections by the publisher, for generating the web-based document including publisher content, and for associating the generated graphic with the web-based document. A bar code scanner, operated by a user, may be included for scanning the graphic with the bar code, and for generating a corresponding code signal. The web server responds to the code signal as the inputted bar code, and provides to the user the web-document associated with the scanned bar code. The graphic is printable by a publisher to be placed on a physical document to be provided to the user for scanning by the bar code scanner.

In addition, the web-based document includes a plurality of panes as sub-pages of the web-based document, with each of the plurality of panes corresponds to respective sets of publisher-specified content.

### BRIEF DESCRIPTION OF THE DRAWINGS

FIG. 1 illustrates a block diagram of the disclosed code-based publishing and content linking access system.

FIG. 2 illustrates the system of FIG. 1 in more detail.

FIG. 3 illustrates a WebDoc with associated panes.

FIGS. 4-10 illustrate flow diagrams of various processing steps by a Discovery Interface.

FIGS. 11-15 illustrate flow diagrams of various processing steps by a Reader Interface.

FIGS. 16-19 illustrate flow diagrams of various processing steps by a Composer Interface.

### DETAILED DESCRIPTION OF THE PREFERRED EMBODIMENTS

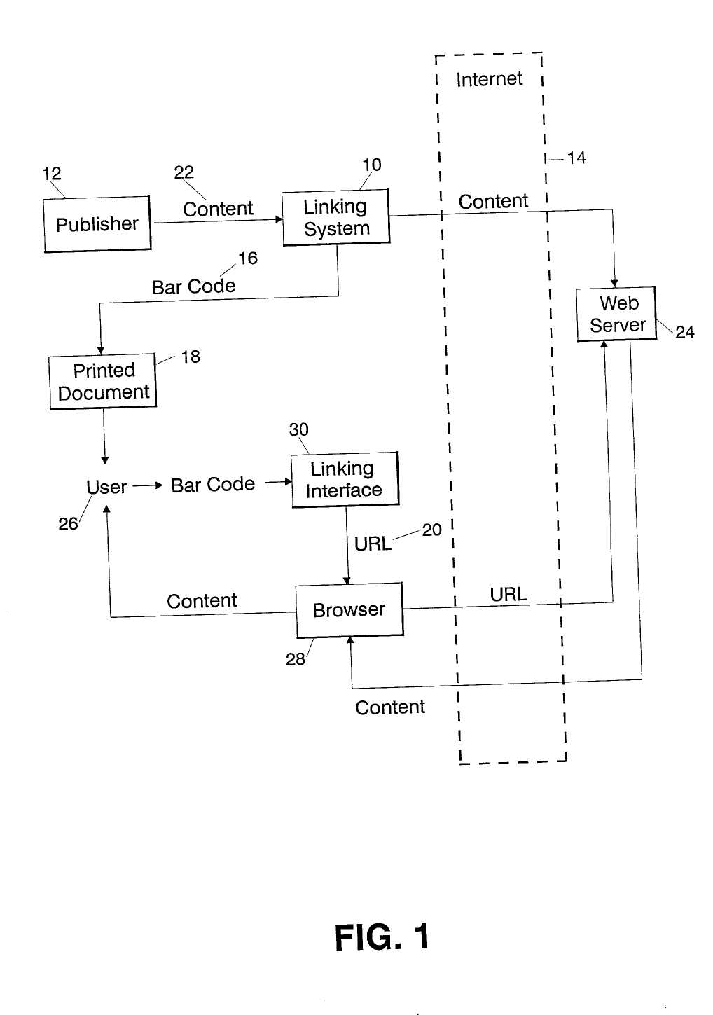

Referring to FIG. 1, a media linking system 10 and method of use are provided which allow users to act as publishers 12 to obtain, via a network such as the Internet 14 and/or the World Wide Web, a graphic file in the form of a bar code 16 and/or alphanumeric identifier tied to the bar code, which can then be inserted (“pasted”) into a print document 18 such as an advertisement. The publisher 12, after downloading a composer program, can provide links to online resources such as URLs 20 and textual descriptions of the content 22 located at that URL 20 and corresponding to the bar code 16. The system 10 includes servers such as web servers 24 which receive this information, including content 22, via the Internet 14 from the publisher 12, and generates the graphic or printed indicia as, for example, the bar code 16, and then sends the indicia 16 to the publisher 12 for inclusion in his printed documents 18. The document 18 can then be printed and distributed to end users 26.

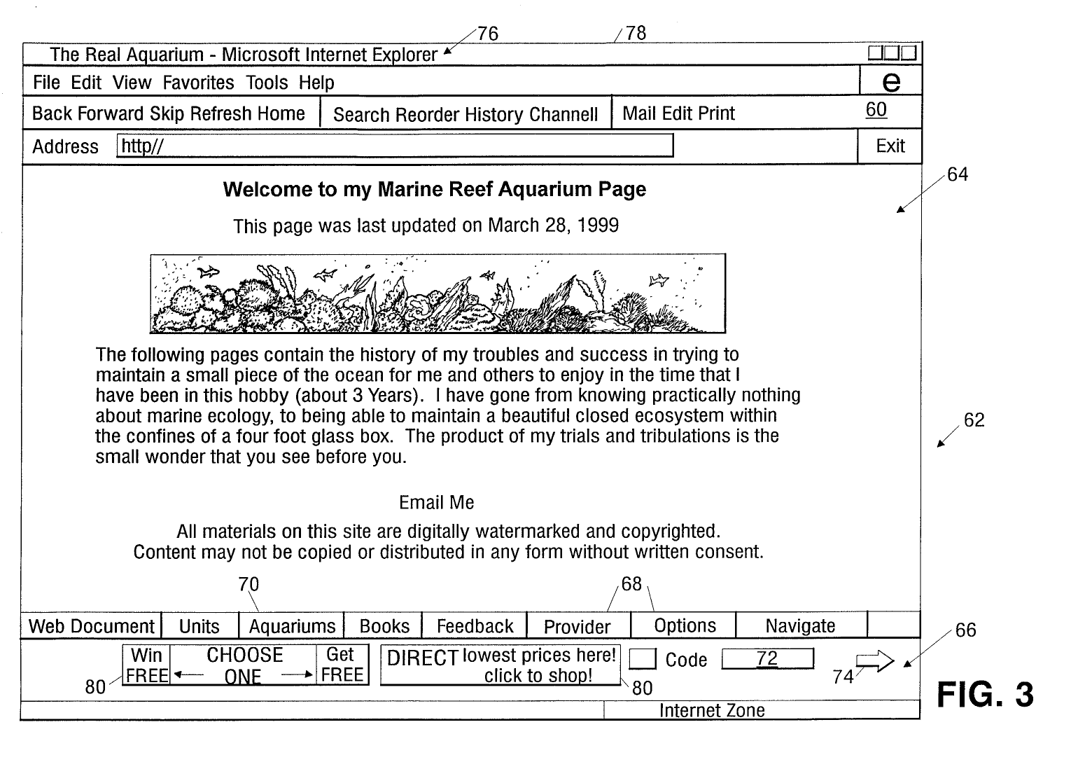

The end user 26 receives, through typical distribution channels such as mailings, magazine ads and the like, the printed document 18 from the publisher 12. If the user 26 is interested in obtaining further information from the publisher 12, the user 26 can access a web site to obtain this additional information, as described herein. The user 26 would open a browser window or input screen on his computer using an Internet browser 28 and access a web site displayed to the user 26. A form or other input field or window, such as shown and described in FIG. 3 herein, appears as the linking interface 30 on the browser 28, into which the user 26 can enter the alphanumeric indicia, such as the bar code 16 and/or a URL 20. If the user is able to use bar code data entry on his computer through the linking interface 30, such as by using a bar code scanner, the user 26 can automate this process by simply scanning the graphic or symbol of the bar code 16 rather than entering the indicia via a keyboard.

With the bar code 16 entered into the linking interface 30, the linking interface 30 automatically retrieves the corresponding URL 20, which is sent to the web server 24 to retrieve and send the content 22 to the user 26 via the browser 28.

The user 26 may also be asked to register and provide certain demographic information to the selected website. After registration, a web page in the form of a frame will be downloaded to the user's browser 28. The frame web page will have certain elements as described herein in accordance with the invention.

This system 10 is available to users through a web site which can be accessed either via a special linkage client program as the linking interface 30, such as an input window overlaying the standard browser screen displaying a website, or via standard web browser with an input form. The pages provided by this site will have a relatively fixed “look and feel.” Publishers 12 are able to create new pages on this site using a web browser-based composer program, which allows them to enter information to be published on the site. As part of this composition process, a graphic will be provided to the publishers for inclusion in their printed materials.

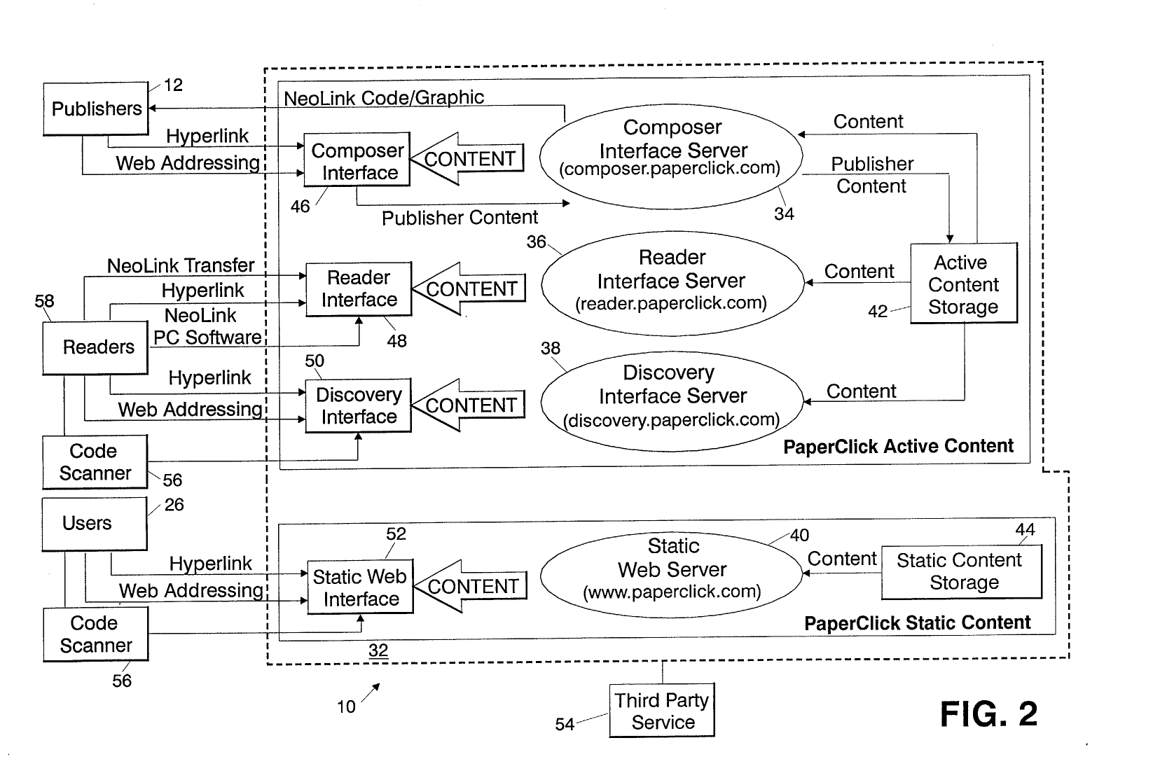

Referring to FIG. 2 in conjunction with FIG. 1, illustrating the disclosed media linking system 10 and method in greater detail, the system 10 includes the following major components:

1. A computer system 32 supporting a plurality of servers 34, 36, 38, 40, such as web servers. In example embodiments, the system may be a “MICROSOFT WINDOWS NT”-based platform and/or a “SUN MICROSYSTEMS” (UNIX) platform, or other server platforms and systems with similar capabilities.

2. Web server software executed by the web servers 34, 36, 38, 40, such as the “NETSCAPE ENTERPRISE” web server and/or “MICROSOFT INTERNET INFORMATION SERVER (IIS)4.0”.

3. A database system for storing both dynamic/active content in an active content storage 42, and static content in a static content storage 44 in the system 10. The storage facilities 42 and 44 may use “ORACLE”-based databases, or other known database systems, such as “MICROSOFT SQL SERVER”.

4. A set of web-server-based interface programs 46, 48, 50, 52, such as common gateway interfaces (CGIs) and external web software such as “MICROSOFT”-based Information Server Application Programming Interface (ISAPI) Dynamic Link Library (DLL) functions, to interface the system 10 to other web-based components and to convert the database information into web content for the users, and to accept input from publishers and readers and to generate the appropriate database information.

5. At least one third-party service 54, such as:

a) a third party web site search service such as “YAHOO”;

b) a third-party web-based book search/purchase service, for example, the “BARNES AND NOBLE” based services at http://www.barnesandnoble.com;

c) a third-party feedback forum software product, which may be integrated into the system's interfaces to provide a universal look-and-feel throughout the system; and

d) a third-party banner advertisement software product or service.

6. Bar code scanners 56, for use by readers 58 and other users such as end users 24 to detect and generate a signal from a bar code 16 affixed or associated with published content, for example, from the publishers 12.

A user such as a reader 58 accesses the system 10 through a dedicated main website, through a code-accessible portal, or through known or standard web browsing methods, such as actuating hotlinks or entering and going to an input URL 20. The pages provided by the main website, such as the webpage shown in FIG. 3, may have a relatively fixed “look and feel.” Publishers 12 are able to create new pages on this site using a web browser-based Composer component, described herein, which allows the publishers to enter information to be published through the site. As part of this composition process, a graphic, containing a unique bar code 16, is provided to the publisher 12 for inclusion in their printed materials.

Organization of Content

As described herein, a WebDoc may be any system-supported page which has been assigned a code such as a bar code 16. Typically, a page of publisher-specified content 22 within the system 10 is assigned a unique code 16.

Referring to FIG. 3, a page is a set of related web-based documents, written in HTML and/or XML. For publisher-defined content, this includes a WebDoc version and all its related content. A pane is a web-based document associated with a page, being a separate document or a set of sub-pages of the web page. Primary content is information stored by the system and provided by a publisher, which may include pages, URL lists, and book references.

A publisher 12 may be any organization or individual who provides primary content on the system 10. Publishers 12 may require authorization or contractual arrangement with the administrators of the system 10 before the publishers 12 are permitted to provide content 22 on the system 10.

A reader 58 is a person or entity which accesses content on the system 10, other than a publisher 12 or administrator, for the purpose of information discovery.

Secondary content is information on the system 10 provided by users 26, which may include newsgroup-style input, chat, etc.

As shown in FIG. 3, the content is organized into “pages” stored on a main server such as a web server 24. Each page 60 supports a frameset 62 having one or more sub-pages or “panes”, such as a content pane 64 and a control pane 66. The system 10 supports at least one of the following pane types:

1. Publisher-specified external content, which is a web page on a server other than the main server.

2. Publisher-specified textual content, which is textual data provided by the publisher, but stored on the main server.

3. Links of web sites related to particular pages.

4. Links to one or more search engines to enable the user to find web sites.

5. Lists of books related to particular pages.

6. Links to one or more sites related to the sale of books.

7. Newsgroup-style online “feedback” forums to allow interaction among users.

8. Chat-style forums to allow real-time interaction among users.

Pages

The Common PaperClick Support Components consist of Web content that provides general support information to users 26. These components are available throughout the system 10.

As shown in FIG. 3 in conjunction with FIG. 1, a portal or home page of the system 10, provided as a linking interface 30 through the browser 28, will provide a control pane 66 adjacent to the content pane 64 and providing hyperlinks or icons 68 and 70 to link to other pages, panes, and/or functions of the linking interface 30. For example, links to a web document, other links or collections of links, specialty links 70 such as for aquariums, books links, feedback links, system provider or sponsor links, and other links for selectable options or navigation controls. Such links or icons 68 and 70 may correspond to specialized panes as described in greater detail herein.

Through the control pane 66, the portal page 60 also provides a mechanism, such as an input window 72, for entering a portal code or other alphanumeric indicia, for example, printed adjacent to the bar code 16 on a printed document 18, for immediate processing and redirection to a PaperClick WebDoc, without the need for input into a specialized Portal Client of the computer of the user 26. In another embodiment, the user 26 may utilized a respective bar code scanner 56 to scan the bar code 16, which then causes the linking interface 30 to enter the corresponding URL 20 as the alphanumeric indicia displayed in the input window 72, which is then automatically processed, or initiated using an activation icon or button 74, to redirect the browser 28 to the URL 20 and its corresponding website at the web server 24.

The home page may also contain banner advertisements for display to users. Navigation to the PaperClick Home Page may be achieved by directly entering the Web address for the PaperClick Home Page (http://www.paperclick.com) into a Web browser 28. Navigation back to the home page from within the system 10 will be achieved by clicking on the “Home” button within the Control Pane throughout the system 10.

A page 60 may display introductory information to the user pertaining to the system 10. Hyperlinks to the Composer Interface 46, the Discovery Interface 50, and FAQ may be provided, as well as links to alternate language versions of the home page. Additional links may be displayed that will promote sponsoring companies and their products.

The PaperClick Home Page provides information regarding the system 10 to readers and publishers, or prospective publishers. A link to FAQ content will be available to provide users with additional support information on using the system 10. Alternate language versions of the home page will also be available via hyperlink. The system 10 may, for example, initially support the English, German, French, and Spanish languages. A hyperlink will be available to the Composer Interface 46 for publisher registration or content definition/modification, as well as to the Discovery Interface 50 for reader content discovery. Links to a sponsoring or administrative entity, such as a “NEOMEDIA TECHNOLOGIES” Home Page (http://www.neom.com), and the Portal PC Software download page (http://www.portal.neom.com) will also be provided. Readers 58 may enter a Portal code or indicia from a bar code 16 into a data-entry field such as the input field 72 in the home page. Upon entering a Portal code and depressing an activation icon 74, such as a “Go” or “Transfer” button, the reader 58 will automatically be redirected to the corresponding PaperClick WebDoc. Additionally, the home page will contain banner ads for display to users.

Panes

Referring to FIG. 3, a particular page 60 may have panes for publisher-specified external content or publisher-specified textual content. Each page has a title 76, which may be displayed on all panes of the page 60, and which is unique among all pages produced by a particular publisher 12. The page titles 76 need not be unique across the entire system 10.

Access to the system 10 is browser-based, and optionally may use additional user-installed programs in conjunction with the system software.

Page access using the system uses system-based codes, which may be bar codes 16 or other indicia, such that each system web page will have a unique system code 16 assigned to the web page 60. Users 26 and/or readers 58 may access a website or web-based services such portals, for example, a web portal called “NEOLINK” available through “NEOMEDIA”. Upon accessing the portal, the user 26 may be navigated directly to the page corresponding to the scanned bar code 16. For example, the user may access the portal through a web server engine such as “TOMAHAWK”. Users who access the “TOMAHAWK” system using the portal system may also be provided with labels, system-generated text, etc. in their portal-registered preferred language.

For readers 58 to access WebDocs there are three methods of accessibility. The first method of accessing WebDocs requires the reader 58 to input a code into portal access software, such as an Internet browser 28 operating with the linking interface 30, or a bar code scanning/reading device 56 operating with associated bar code processing software. This may occur through manual entry via the input field 72 or by barcode scanning. If the bar code is associated with an active WebDoc, the reader 58 will be redirected, via the web browser 28, to that specific web address. Here, the reader 58, through the PaperClick Reader Interface, may view the WebDoc and its related content.

As described herein, the Discovery Interface 50 facilitates WebDoc accessibility for readers 58 accessing the system 10 through standard Web browsing methods, that is, without utilizing a Portal Client. Navigation to the Discovery Interface 50 occurs via hyperlink from the PaperClick Home Page, or by directly addressing the Discovery Interface 50 through the web browser 28, for example, by inputting the URL 20 such as http://www.discovery.paperclick.com. From within the Discovery Interface 50, the reader 58 is provided with an alternate methods for accessing WebDocs. Again, the reader 58 will view their desired WebDoc and its related content through the Reader Interface 48.

As a third method of accessing WebDocs, a reader 58 may input a code 16 into any Portal Transfer field such as the input field 72 found in panes throughout the system 10. This allows users not accessing a portal website to access the system 10 by visiting any system-related website.

For publishers 12, the Composer Interface 46 allows them to register and define WebDoc content associated with a bar code 16, and provides them with the opportunity to download or print their Portal code graphic onto a printed document 18. Navigation to the Composer Interface 46 occurs via hyperlink from the PaperClick Home Page, or by directly addressing the Composer Interface 46 through a web browser 28 through a URL 20 such as http://www.composer.paperclick.com.

Each of the interface 46, 48, 50, and 52 in FIG. 2 preferably has a common “look and feel”. To facilitate this, several user interface components have been defined that are universal throughout the system 10. These components comprise the Common PaperClick Interface Components.

Referring to FIG. 2, the Common PaperClick Support Components also include static Web content stored in static content storage 44 that provides general support information to all users.

If a user accesses a bar code 16 for a page that has not yet been activated, the system 10 generates a web page indicating the scheduled activation date for that page, and allows a user to look for other pages. If a user accesses a bar code 16 for a page that has been deactivated, the system 10 generates a page containing an appropriate message, and allows the user to look for other pages.

Page access may also be effected without using a portal, such that a user not equipped with the code-based system 10, or not possessing the bar code for a particular page may navigate in from the Internet 14 and/or the World Wide Web, or other third-party services 54.

The system 10 locates web pages via their titles, via their publishers, and/or listed of pages ordered by creation date, ordered most-recent to least-recent. The list of pages may also be ordered by activity on its feedback forum, from most-active to least-active, or by a list of pages which have active chat access.

Using the system 10, a user 26 may search for pages by keyword, to find pages with those keywords in the page title or associated with the page by the publisher 12. The search process only returns pages that are currently active.

Users 26 on one “TOMAHAWK” page may navigate to other “TOMAHAWK” pages. A user 26 leaving “TOMAHAWK” page to find another “TOMAHAWK” page may have all the page location options available to a user 26 navigating in from the web, plus the addition of a shortcut to other pages created the publisher 12 who created the page the user 26 is leaving.

Navigation among and between panes may also be provide, with each active pane on the same page may be accessed by active/actuatable regions or hotlinks in the pane. A page may have pane access activated on the pane only for panes that are available.

The Common PaperClick Interface Components consist of Web browser-based user interface features that are universal throughout the system interfaces 46, 48, 50, and 52. These components comprise the functional framework of the system 10, and provide a publisher 12 with the flexibility to create customizable primary content, while maintaining the same “look and feel” across the system 10 for their readers 58. As described herein, the primary components of the Common PaperClick Interface consist of a Web browser-based frameset 62 containing at least two panes: the content pane 64 and the control pane 66, with access to other panes available through the icons 68 and 70 included in or adjacent to the control pane 66.

There are two methods of initial entry into the system 10. A reader 58 may either be directed into the system 10 through code submission into the Portal PC Software (via scanner or manual entry) or by simple Web browser navigation. The Composer Interface 46, Reader Interface 48, and Discovery Interface 50 will provide the user 26 with the same user interface components (i.e. a Frameset 62 with a Content Pane 64 and Control Pane 66); however, the content displayed within each of these components will differ.

After initial entry into the system 10, a user 26 may navigate to other pages within the system 10 via embedded hyperlinks within the Content Pane 64, or by utilizing the navigational features and icons 68 and 70 found within the Control Pane 66.

To leave the system 10, a user 26 may navigate to other Web pages external to the system 10 via embedded hyperlinks located within the Content Pane 64 or Control Pane 66, or by entering a new Web address within their Web browser 28.

The system 10 will be user-friendly. If a reader 58 accesses a Portal code or bar code 16 for a page that has not yet been activated, the system 10 will generate a Web page indicating the scheduled activation date for that page, and provide the reader 58 with the ability to look for other pages. If a reader 58 accesses a Portal code 16 for a page that has been deactivated, the system 10 will generate a page containing an appropriate message, and allow the reader 58 to look for other pages.

The Frameset

Referring to FIG. 3, the structure of the system 10, as seen by the user will be organized into “pages” 60, with each page 60 supporting at least two sub-pages or “panes” 64 and 66. A frameset 62 is a way to divide a single Web document into regions that can display multiple HTML documents. The content of each pane 64 and 66 will be dependent upon which Web page within the system 10 that is being currently displayed.

The purpose of the frameset component 62 is to encapsulate the Content Pane 64 and Control Pane 66 contained therein. The frameset 62 will also contain the title 76 of the active PaperClick page. This title 76 will be displayed in the title bar 78 of the browser 28 for all panes 64 and 66 associated with this page 60.

The Control Pane

The Control Pane component 66 is an HTML document within the PaperClick Frameset 62 that serves as a navigational aid for the user. The Control Pane 66 will provide the user 26 with the opportunity to navigate to other Web pages that might be of related interest. A hyperlink to the PaperClick Home Page may always be available. The Control Pane 66 will also provide the mechanism 72 for entering a Portal code 16 for immediate redirection to another PaperClick WebDoc, without the need for input into the Portal Client. Additionally, the Control Pane 66 may also contain banner advertisements 80 for display to users 26. The Control Pane 66 will enhance the user's Web experience by organizing Web content that is related to their interest (as determined by the inputted Portal bar code 16) into a central repository for easy reference and navigation.

The Control Pane 66 will enhance the publisher's Web experience by organizing their WebDoc content into a central repository for easy reference and navigation.

The Control Pane 66 will provide a simple method for visiting the PaperClick Home Page, and for entering a code for processing. The Control Pane 66 also allows for revenue generation by providing the use of banner advertisement and commission from sales paid by commercial Web site referrals.

The Control Pane 66 will use a “tab folder” metaphor using the links 68 and 70 to simplify user navigation. Each “tab” control will represent a hyperlink to another PaperClick Web page that will be displayed in the Content Pane 64. Only tabs linked to relevant, available content will be displayed for a particular Web page. Hence, as the content displayed in the Content Pane 64 changes, so may the tabs 68 and 70 available for navigation.

Multiple versions of the Control Pane 66 may exist throughout the system 10. Each version will have the same “look and feel”, however the labels and links associated with each tab control will vary depending on the interface being viewed. Through the respective interfaces 46, 48, 50, and 52, the Reader Control Pane tabs will relate directly to the current WebDoc topic. The Discovery Control Pane tabs will facilitate readers' WebDoc discovery. Finally, the Composer Control Pane tabs will assist publishers 12 in developing their WebDoc content.

All pages will have provisions available whereby the user 26 may visit the PaperClick Home Page, or enter a Portal bar code 16 into a data-entry field within a Control Pane 66. Upon entering a Portal bar code 16 and depressing the “Transfer” button 74, the user 26 will automatically be redirected to the corresponding PaperClick WebDoc. Additionally, the Control Pane 66 will display banner ads 80 to users 26 that may change every time the user navigates to a different page within the system 10.

The Content Pane

The Content Pane component 64 is an HTML document within the PaperClick Frameset 62 that is to contain the main informational content for a particular page within the system 10. The content of this pane 64 will dynamically change according to navigational direction from the user 26. The Content Pane 64 will display informational content that the user 26 has selected based on their navigational instruction. The content of the Content Pane 64 may be dynamic in nature and is dependent upon the manner of navigation the user 26 has selected to bring him to a particular PaperClick Web page 60.

When a user 26 initially accesses a “TOMAHAWK” page, the main content pane 64 is presented to the user 26. The main content pane will consist of either publisher-supplied external content or publisher-supplied textual content, at the option of the publisher 12.

There may be no restrictions on the HTML content of publisher-supplied external content. Publisher-supplied textual content will support the optional inclusion of a subset of HTML commands. The main content pane 64 is required for all pages.

The system 10 allows the publisher 12 to choose between external and textual content for a page 60. If the publisher 12 chooses external content for a page, he or she will be required to specify a URL 20 for that content 22. If a publisher 12 chooses textual content for a page, the publisher 12 may be required to provide the textual content via a web form. Publisher-supplied textual content may be limited to a maximum of, for example, 1,800 characters.

Other panes described herein may be displayed in the frameset 62 in various ways, for example, as actuatable tabs 68 and 70 shown in FIG. 3, as well as expandable windows or split frames in the content pane 64. Such panes are described herein as follows:

Related Web Sites Pane

The system 10 may support a pane in which web sites related to the page topic may be displayed. The web sites pane will be optional for a particular page, at the discretion of the publisher 12. The web sites pane will support the following:

links to web sites (URL's);

links to “keyword” or “key phrase” searches in a third-party search engine; and

a link to the main entry point in a third-party search engine.

The system 10 allows the publisher 12 to elect whether or not a page 60 will contain a web sites pane, and to manually specify a list of URL's that should be included in the web sites pane. The system 10 will include an interface to a third-party web search engine or service 54 that will assist publishers 12 in locating relevant web sites and keyword searches to be included in the pane. All web sites and keyword search links included in the pane will require approval by the publisher.

The Books Pane

The system 10 may support a pane in the set of tabs 70 in which, upon access of the respective tab, a books pane related to the topic of the currently displayed page 60 may be displayed. The books pane will be optional for a particular page, at the discretion of the publisher. The books pane will support the following:

a list of book titles;

links between the book titles and an on-line book sales site such as Amazon or Barnes and Noble;

links to searches in a third-party book search engine by author;

links to searches in a third-party book search engine by subject or keyword; and

a link to the main entry point in a third-party book search engine.

The system 10 also allows the publisher 12 to elect whether or not a page will contain a books pane, and to manually specify a list of books that should be included in the books pane. The system 10 will include an interface to a third-party book search engine that will assist publishers in locating relevant web sites, keyword and author searches to be included in the pane. All books, keyword and author search links included in the pane will require approval by the publisher.

The Feedback Pane

The system will support a pane, as shown in the tabs 70 of FIG. 3, via which the user 26 may enter his or her opinions, comments, etc. on the page topic. The feedback pane will be optional for a particular page, at the discretion of the publisher 12. The feedback area will be unmoderated. Users 26 will be presented with an appropriate warning of this fact.

The system 10 allows the user 26 to read the feedback provided by others. Information under the feedback area will be organized into topic “threads.” Users 26 will have the ability to create a new thread, and to enter a response to a particular previous “post” in the feedback forum.

The system 10 also permits the publisher 12 to elect whether or not a page will contain a feedback forum, and to optionally specify one or more initial thread subjects for the feedback forum. If the publisher 12 fails to specify at least one thread subject, the page title 76 will be used as the initial thread subject.

The Chat Pane

The system 10 will support an on-line “chat” capability. Chat capabilities will be optional for a particular page, at the discretion of the publisher. Chat support will be unmoderated. The duration of chat support for a particular page will be limited to a particular, pre-defined period of time.

Prior to the “start” time for chat support on a particular page, the chat pane link on the page will indicate the scheduled time period for which chat will be supported.

The system 10 allows the publish to elect whether or not a page will contain a chat forum, and to schedule the duration over which the chat forum will be active.

Advertisements

The system 10 is also capable of displaying banner ads 80 to users 26. The system 10 will support the capability of changing the displayed banner ad every time the user changes panes or pages.

Access Requirements

Each publisher 12 will be registered with the “TOMAHAWK” system. As part of the registration process, the publisher 12 will be issued a login ID and password. In order to gain access to the “TOMAHAWK” system, a publisher 12 will be required to provide his or her login ID and password. The system 10 will support an optional feature whereby access to a particular publisher's capabilities can be restricted to a particular set of IP addresses. No publisher will have editorial access to any page created by another publisher.

The system 10 allows access to each type of optional pane may be enabled or disabled on a per-publisher basis. Publishers will be required to provide an email address via which the system may issue any appropriate automatically generated warnings, reminders and notifications. Each publisher will be either “active” or “inactive” at any time.

Inactive publishers will have no access to the system other than as users. Pages associated with inactive publishers will be not be automatically disabled.

Page Creation Requirements

The system 10 also allows a publisher 12 to create a new page. The page creation process will be a distinct operation from the page composition process. The publisher will be required to provide the following information during the page creation process:

the unique title of a page;

an optional list of keywords to be associated with the page; and

the scheduled date on which the page will become active.

Once a page is created, the publisher will be able to retrieve a Portal code associated with the page.

Page Composition Requirements

The system 10 also allows a publisher 12 to specify the main pane content 64 of a page 60, and to elect whether or not a page should contain each of the optional panes. Page composition will be performed through a web browser form-based interface as the Composer Interface 46. Through the system 10, a publisher may view a page that has been composed but which is not active.

FAQ Content Page

The FAQ Content Page will display a list of system 10 support information in the form of questions and answers. The information will be categorized by type of FAQ reader. The three basic types of FAQ readers will include “PaperClick Content Readers”, “PaperClick Content Publishers”, and “Potential PaperClick Content Publishers”. Navigation to the FAQ Content Page will be achieved by clicking on the “FAQ” control tab within the Discovery and Composer Control Panes, as well as via hyperlink from the PaperClick Home Page.

The FAQ Content Page is a system-installed navigational aid. The system 10 administrator will be responsible for maintaining the list of FAQ organized by target user.

Options Page

The Options Content Page, accessible through the Options tab in the set of icons 70 in FIG. 3, will display to the reader a form for submitting or updating their personal information and preferences. Navigation to the Options Content Page for readers will be achieved by clicking on the “Options” control tab within the Discovery and Reader Control Panes. The Options Content Page is a system-installed navigational aid. This page will allow readers to customize their PaperClick session by specify their preferred language. The system 10 will initially support the English, German, French, and Spanish languages. A reader 58 will also be provided the capability to login or register with the system 10, request support for a forgotten password, or modify their registration information.

Readers 58 who access the system 10 will be provided with labels, system-generated text, etc. in their portal-registered preferred language, provided that the system 10 supports the language. The system 10, however, will not provide translations for content entered by a publisher. For readers accessing the system 10 via Web browser navigation, the default preferred language would be derived from the language of the PaperClick Home Page version last accessed.

Paperclick Virtual Communities

The system 10 will support the creation of virtual communities. Users will be able to meet on-line within the system 10 to discuss their common interests. Readers of PaperClick content will be able to provide feedback pertaining to the current WebDoc topic or category, while PaperClick publishers can share ideas with their counterparts. Forum functionality will be provided by third-party software (TBD). This software will be integrated with the system 10 user interface components in order to incorporate the system 10's universal look and feel.

Forum Pane

The Forum Content Pane will display to the user an unmoderated feedback forum where they may enter and share their opinions, comments, etc. The system 10 will also allow a user to read the feedback provided by others. Navigation to the Forum Content Pane for readers will be achieved by clicking on the “Forum” control tab within the Reader Control Pane for a specific WebDoc. Navigation to the Forum Content Pane for publishers will be achieved by clicking on the “Forum” control tab within the Composer Control Pane.

The Forum Content Pane is a secondary content pane available to readers within the Reader Interface, and publishers within the Composer Interface. Publishers may elect to install the “Forum” control tab to each of their WebDocs' Reader Control Pane. The “Forum” control tab within the Composer Control Pane is system-installed. Since all secondary content is unmoderated, the users will be presented with a warning of this fact. Publishers must be signed-on to the system 10 prior to accessing a forum. Readers, however, may access a forum, but will be prevented from posting new information to a forum group unless they have identified themselves to the system 10. If a reader has not previously signed-on to the system 10, the reader will be displayed a Login Pane prior to the display of the feedback forum. The Login Pane will require a reader to enter a Login ID and Password, or register with the system 10. The login name used in the forum will be the same as is used elsewhere in the system 10.

Information under the feedback forum will be organized into topic groups. Publishers and identified readers will have the ability to post new messages to an existing topic group or enter responses to existing messages within a group. Posts made by a user will include the login name of the user, and the date and time at which the post was made.

Page Editing Requirements

The system 10 permits a publisher to modify the content of an existing page. A publisher will be permitted to modify a page either before it becomes active or after it becomes active.

Page Removal Requirements

The system 10 also allows a publisher to deactivate a page; however, deactivation of a page may not cause the page content to be immediately removed from the system 10. The system 10 also permits a publisher to re-activate a page that has been deactivated.

The system will automatically remove pages that have remained deactivated for more than a preset period of time. Operator access to the system will require a login ID and password.

Publisher-related Requirements

The system 10 permits publishers to be added to the system, and to have their login ID and password properly altered. In addition, the system 10 may cause IP address restrictions for a particular publisher to be added, edited or removed, and to alter an active or inactive state of the publisher.

Page-related Requirements

The system 10 allows an operator to activate or deactivate a page. Operator activation or deactivation of a page owned by an active publisher will cause an automatic email notification to be sent to the publisher notifying him or her of this action.

Logging Requirements

The system will keep a record of the Portal User ID of each user accessing a page via a Portal code. A log entry will be made only for page access, not for access to each individual pane on a page.

If a user initially accesses the system via a code and then manually navigates to another page, the subsequent page reference will be logged as if the user navigated to that page via the code. Users who access the system 10 from the web will be assigned an arbitrary non-Portal user ID on their initial page access.

Link Accuracy

The system 10 also permits verification, including automatic verification, of the continued existence of all web links in the system. Web links that are not longer active will be automatically removed from the system. When a web link is removed from a page or pane belonging to an active publisher, an email will automatically be sent indicating such removal.

The Discovery Interface

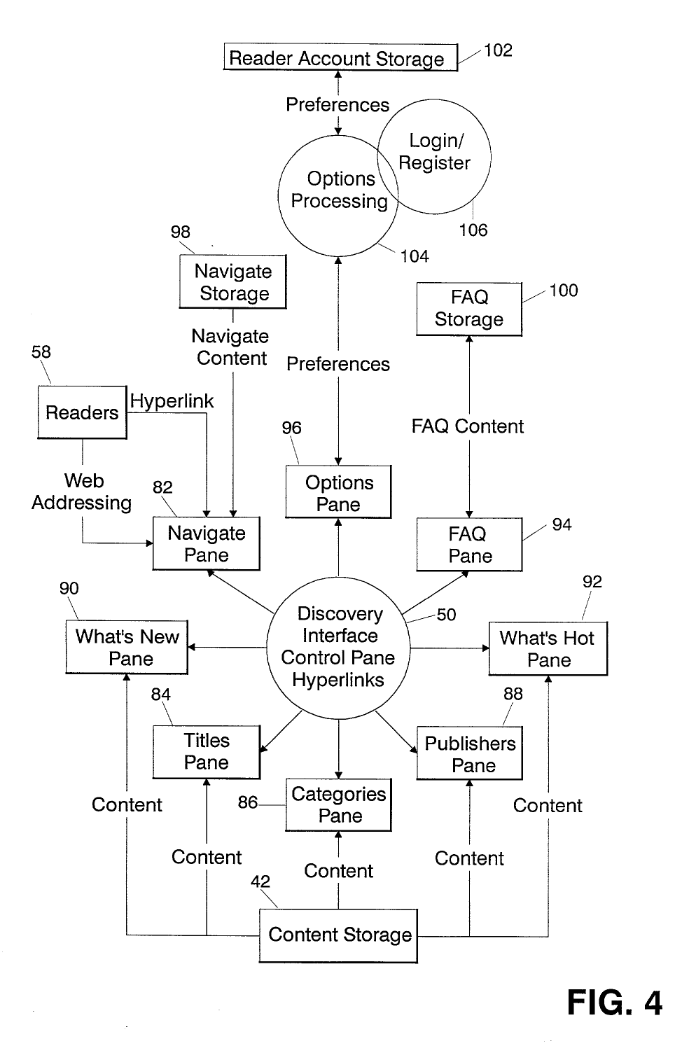

Referring to FIG. 2 in conjunction with FIGS. 4-10, the Discovery Interface 50 allows readers not equipped with portal-accessing components or software, or not possessing the code for a particular WebDoc, to access a webpage within the system 10. Access to the Discovery Interface 50 may be obtained through ordinary web browser navigation to a dedicated homepage permitting such discovery access, such as a “PAPERCLICK” home page at http://www.paperclick.com. From the home page, the reader may hyperlink to the Discovery Interface 50. For advanced users, direct access to the Discovery Interface is also available by entering a specific web address into a browser, such as http://wwww.discovery.paperclick.com. Within the Discovery Interface 50, the reader 58 is presented with the Common PaperClick Interface Components described herein, such as the Frameset 62, Control Pane 66, and Content Pane 64 shown in FIG. 3.

Referring to FIG. 4, the operation of the Discovery Interface 50 permits readers 58 to access various associated panes. For example, in conjunction with the Discovery Interface's Navigate Pane 82, a collection of related content is available to the reader via the tab controls found on the Discovery Control Pane 66. The related content available to the reader is predetermined by the system 10, and allows the reader to target specific, available, active content. These system-generated lists of pages presented for reader navigation is broken into groups of entries, such that the number of entries presented at any particular time is no more than approximately one screen's worth. Additionally, if a reader has a code, the reader may enter the code 16 within the Discovery Control Pane for processing.

The Discovery Control Pane provide hyperlinks to the following panes:

Navigate 82—the Discovery Interface main page.

Titles 84—hyperlinks to WebDocs organized by title.

Categories 86—hyperlinks to WebDocs organized by category.

Publishers 88—hyperlinks to WebDoes organized by publisher.

What's New 90—hyperlinks to the latest WebDoc additions organized by date.

What's Hot 92—hyperlinks to the most active WebDocs organized by activity.

FAQ 94—Frequently Asked Questions pertaining to the system.

Options 96—user options that allow a reader to customize their content-accessing experience.

Various storage and processing components are included to support corresponding panes. For example, the content associated with the navigate pane 82 is stored in navigate storage 98, while FAQ information/content is stored in FAQ storage 100. Various preferences and customizable options are stored in reader account storage 102 for use in options processing 104 and/or login and registration processing 106.

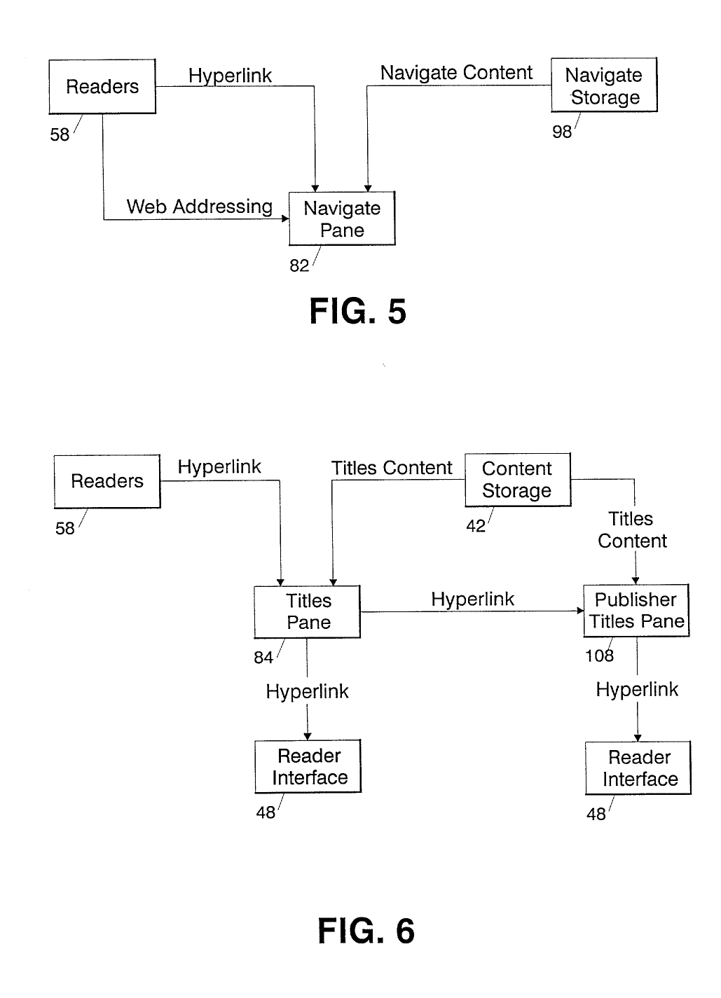

Referring to FIG. 5, the Navigate Content Pane 82 operates to display to the reader instructions on locating and displaying PaperClick WebDocs. The Navigate Content Pane 82 is considered the main page of the PaperClick Discovery Interface 50. Initial navigation to the Navigate Content Pane 82 is achieved by hyperlinking from a home page such as http://www.paperclick.com, or by entering the Discovery Interface Web address into a browser such as http://discovery.paperclick.com. Navigation back to the Navigate Content Pane 82 for readers within the Discovery Interface 50 is achieved by clicking on the “Navigate” control tab within the Discovery Control Pane.

The Navigate Content Pane 82 is a system-installed navigational and informational aid. The reader is given instructions for performing WebDoc discovery. A generic search form field and search button may also be available. A drop-down list box allows the reader to target their search by optionally selecting specific search criteria.

Referring to FIG. 6, the Discovery Interface Titles Content Pane 84 will display to the reader a list of PaperClick WebDocs organized by title, including a hyperlink to a publisher-specified titles pane 108. The list of sites will include a description of each WebDoc, the publisher of that WebDoc, and a hyperlink to that WebDoc site. Additionally, the reader may perform a keyword search on active PaperClick content. Navigation to the Titles Content Pane 84 for readers will be achieved by clicking on the “Titles” control tab within the Discovery Control Pane. The Titles Content Pane 84 is a system-installed navigational aid. The system will be responsible for maintaining a list of available, active PaperClick content organized by title. The system 10 will add the list of link sites by title, including descriptions, URLs and publishers, for display in the Titles Content Pane 84. A generic search form field and search button will also be available. A drop-down list box will allow the reader to target their search by optionally selecting specific search criteria.

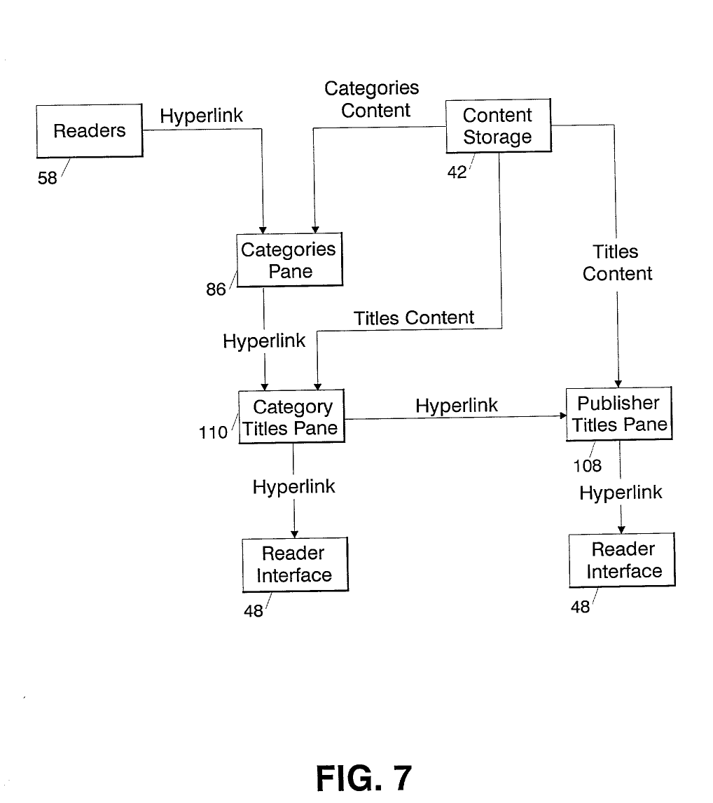

Referring to FIG. 7, the Discovery Interface Categories Content Pane 86 will display to the reader a list of PaperClick WebDoc categories. Each category will be linked to a document containing a list of WebDocs for that category, including a hyperlink to the publisher titles pane 108. The list of sites will include the title and description of each WebDoc, publisher of the site, and a hyperlink to that WebDoc site. Additionally, the reader may perform a keyword search on active PaperClick content. Navigation to the Categories Content Pane for readers will be achieved by clicking on the “Categories” control tab within the Discovery Control Pane.

The Categories Content Pane 110 is a system-installed navigational aid. The system 10 will be responsible for maintaining a list of categories for available, active PaperClick content. Each category will be associated with a list of WebDocs via hyperlink. The system 10 will generate the list of link sites by category, including descriptions, URLs and publishers. A generic search form field and search button will also be available. A drop-down list box will allow the reader to target their search by optionally selecting specific search criteria.

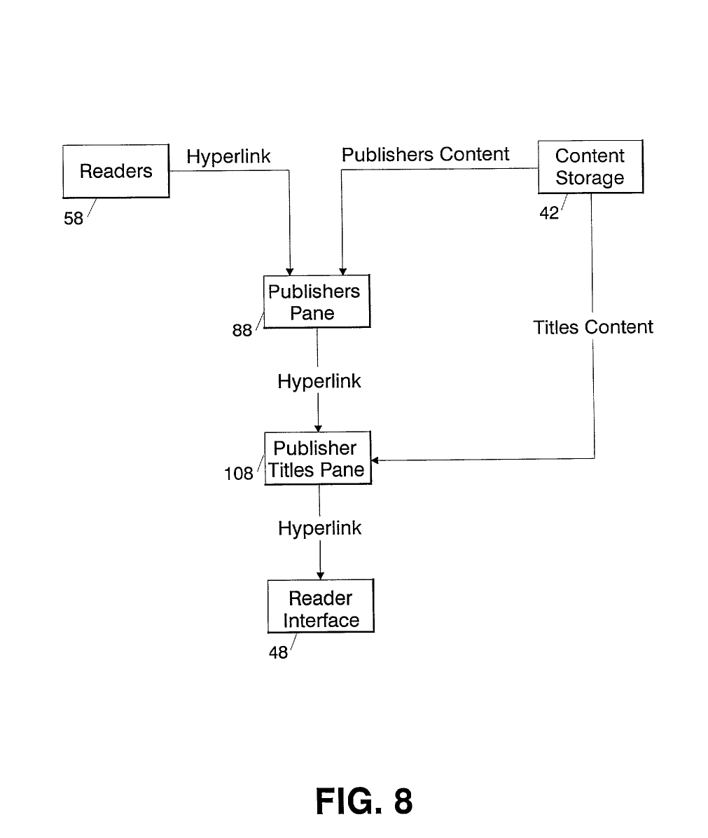

As shown in FIG. 8, the Discovery Interface Publishers Content Pane 88 will display to the reader a list of PaperClick WebDoc publishers, including a link to the publisher titles pane 108. Each publisher name will be linked to a document containing a list of WebDocs for that publisher. The list of sites will include the title and description of each WebDoc, and a hyperlink to that WebDoc site. Additionally, the reader may perform a keyword search on active PaperClick content.

Navigation to the Publishers Content Pane 88 for readers will be achieved by clicking on the “Publishers” control tab within the Discovery Control Pane. The Publishers Content Pane is a system-installed navigational aid. The system 10 will be responsible for maintaining a list of publishers with available, active PaperClick content. Each publisher will be associated with a list of WebDocs via hyperlink. The system 10 will generate the list of link sites by publisher, including descriptions and URLs. A generic search form field and search button will also be available. A drop-down list box will allow the reader to target their search by optionally selecting specific search criteria.

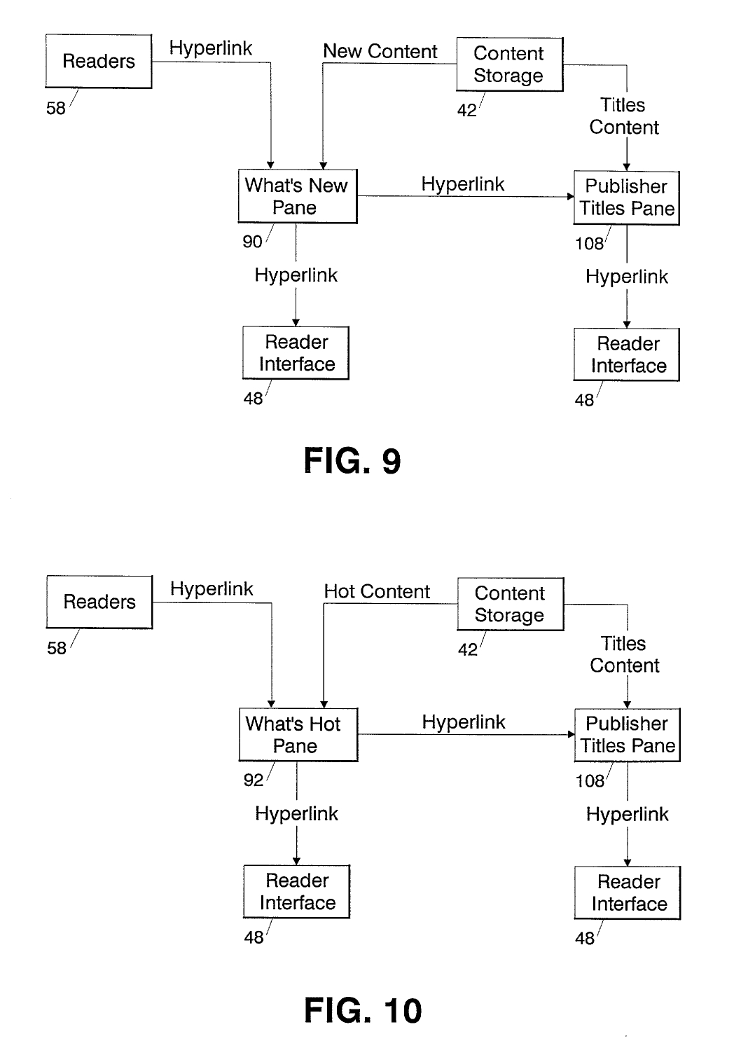

Referring to FIG. 9, the Discovery Interface “What's New” Content Pane 90 will display to the reader a list of the latest PaperClick WebDocs organized by activation date (descending). The list of sites will include the title and description of each WebDoc, publisher of the site, and a hyperlink to that WebDoc site, as well as a link to the publisher titles pane 108. Additionally, the reader may perform a keyword search on active PaperClick content. Navigation to the “What's New” Content Pane 90 for readers will be achieved by clicking on the “What's New” control tab within the Discovery Control Pane. The “What's New” Content Pane 90 is a system-installed navigational aid. The system 10 will be responsible for maintaining a list of available, active PaperClick content organized by activation date. The organization of the activation dates will be in descending order, from the most recent to the least recent. The system 10 will generate the list of link sites by activation date, including descriptions, URLs and publishers. A generic search form field and search button will also be available. A drop-down list box will allow the reader to target their search by optionally selecting specific search criteria.

Referring to FIG. 10, the Discovery Interface “What's Hot” Content Pane 92 will display to the reader a list of the most frequently accessed PaperClick WebDocs organized by activity (descending). The list of sites will include the title and description of each WebDoc, publisher of the site, and a hyperlink to that WebDoc site, as well as a link to the publisher title pane 108. Additionally, the reader may perform a keyword search on active PaperClick content. Navigation to the “What's Hot” Content Pane for readers will be achieved by clicking on the “What's Hot” control tab within the Discovery Control Pane. The “What's Hot” Content Pane is a system-installed navigational aid. The system 10 will be responsible for maintaining a list of available, active PaperClick content organized by activity. The organization of the activity will be in descending order, from the most active to the least active. The system 10 will generate the list of link sites by activity, including descriptions, URLs and publishers. A generic search form field and search button will also be available. A drop-down list box will allow the reader to target their search by optionally selecting specific search criteria.

The Reader Interface

The primary function of the Reader Interface 48 is to view WebDocs. Readers who access the system 10 using a portal will automatically be navigated directly to the WebDoc corresponding to a bar code 16. Additionally, a reader may be navigated directly to a WebDoc by entering a bar code 16 into the Control Pane found on any system-based web page, or by hyperlinking to a desired WebDoc via the navigational methods found within the Discovery Interface 50.

As an individual reader access the system 10 through a respective Reader Interface 48, the system 10 establishes a session for each reader, to perform one or more of the following: session, reader, and cookie logging; session tracking via dynamically generated URLs containing a session ID; session tracking via a session cookies; reader/computer tracking via machine-based cookies; reader tracking via a user ID; reader tracking via a login procedure; integration into a registration database for tracking readers and their demographics; expiring a session after a predetermined duration of inactivity, such as one hour, from the originating IP address; and transparent session regeneration for invalid/expired sessions.

The system 10 is also capable of permitting banner ad companies to tune the display of banner ads to individual readers. In one example embodiment, the system 10 may provide to the banner ad companies a portion of the demographic information of readers tracked by the system 10. Accordingly, using such demographic information of a particular reader at a given point, such as when the reader initiates access to a website with particular content, the banner ad company can tune the banner ads to be displayed when the website and/or the particular content is displayed to the reader. For example, banner ads strongly related to the demographics, such as hobbies and interests, of the accessing reader are provided to the reader with the display of the desired content. The system 10 thus provides for control of click-through activity with websites and banner ads in relation to individual readers, thus enhancing their browsing experience as well as the effectiveness of the banner ads.

In another embodiment, as a reader accesses and clicks through websites, such as publisher pages, the system 10 can track and identify each reader to know who the reader is and where the reader has come from and is going; that is, the websites previously accessed by the reader before accessing a publisher page, and any websites accessed after viewing of the publisher page. Accordingly, the system 10 allows for reader tracking to support revenue splitting, for example, to banner ad companies for those particular banner ads displayed as the reader clicks through various websites. For example, a portion of the revenue derived from a banner ad click-through could be paid to the publisher from whose page the reader went from.

Similarly, the system 10 may track click through activities of readers as they access various panes, such as the Books pane tab in the tabs 70 of a frameset 62 as in FIG. 3. In this manner, using demographics and reader tracking, publishers are given a greater incentive to put content for access by readers through networks such as the Internet, which in turn should increase revenues from E-commerce applications and banner ad placements.

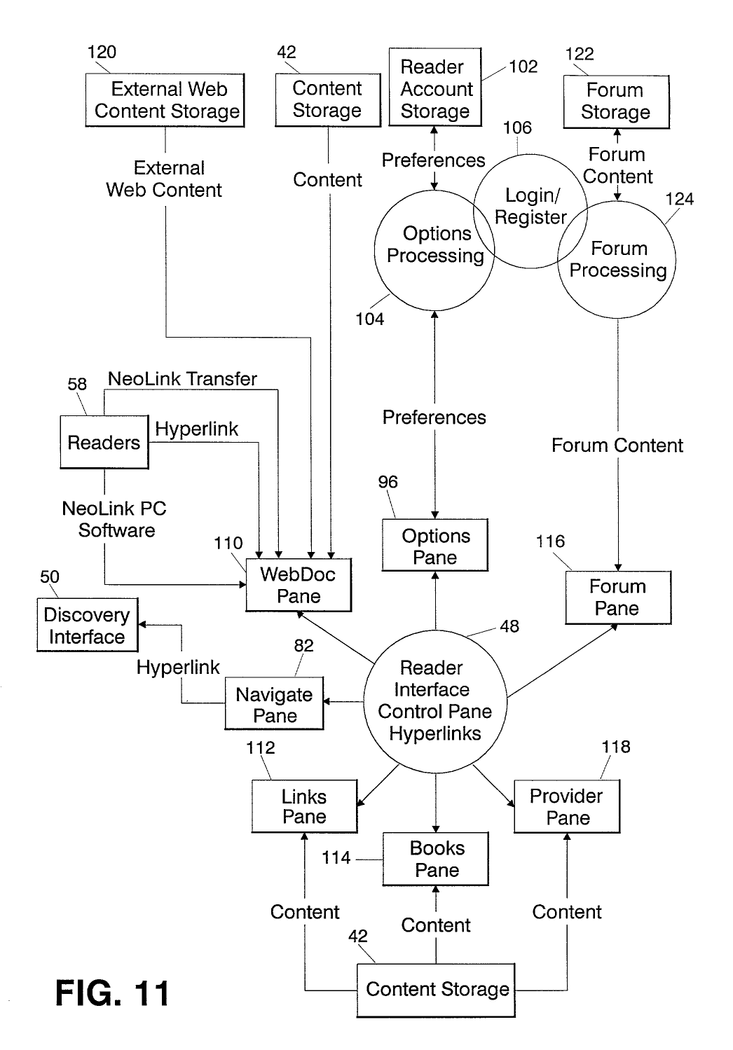

Referring to FIG. 11, the Reader Control Pane provides, in conjunction with the WebDoc content, a collection of related content made available to the reader via the tab controls found on the Reader Control Pane. The related content available to the reader for a particular WebDoc is predetermined by the WebDoc publisher. The publisher will determine the number and labels of the associated tab controls for each WebDoc by defining the related content to be available for each WebDoc. Several predefined content pane templates will be available for a publisher to include with their WebDoc's Reader Control Pane tab controls.

The Reader Control Pane may provide links to the following Content Panes:

WebDoc 110—the current PaperClick WebDoc.

Links 112—hyperlinks to Web sites related to particular WebDoc content.

Books 114—lists of books related to particular WebDoc content with links to one or more sites related to the sale of books.

Forum 116—newsgroup style online forums to allow interaction among readers concerning the particular WebDoc content.

Provider 118—information regarding the publisher of particular WebDoc content.

Options 96—user options that allow a reader to customize their PaperClick experience.

Navigate 82—hyperlink to the PaperClick Discovery Control Pane.

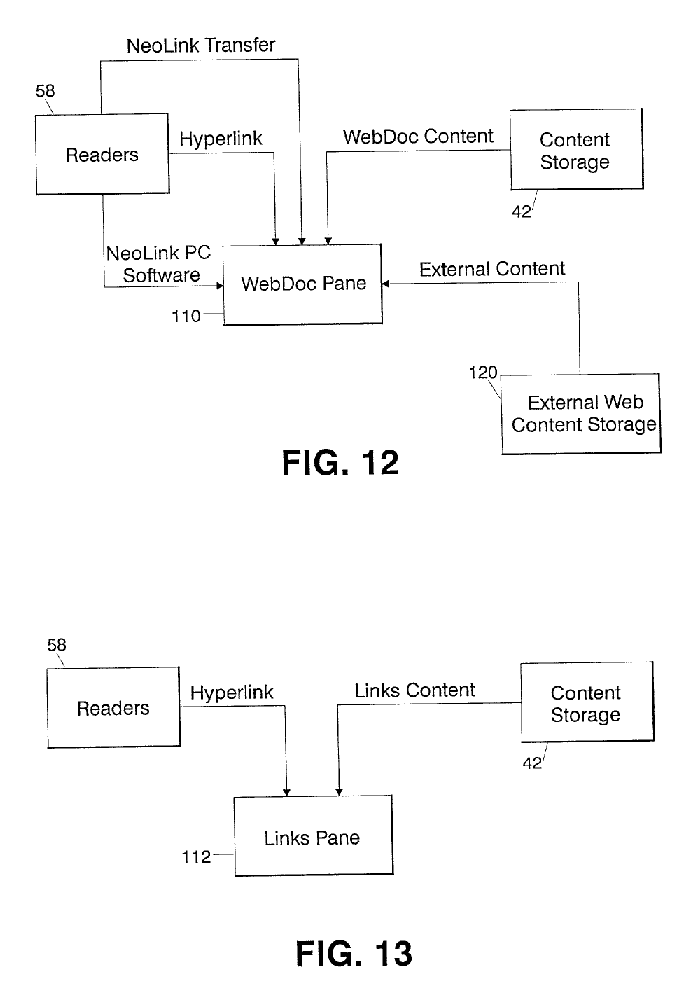

Referring to FIG. 12, through the Reader Interface 48, a WebDoc Content Pane 110 displays to the reader the current WebDoc. The WebDoc Content Pane 110 is considered the main page of the PaperClick Reader Interface 48. Readers who access the system 10 using the Portal Client will automatically be navigated directly to the PaperClick WebDoc corresponding to a Portal bar code 16. Additionally, a reader may be navigated directly to a WebDoc by entering a Portal bar code into the Control Pane found on any PaperClick Web page, or by hyperlinking to a desired WebDoc via the navigational methods found within the Discovery Interface. Navigation back to the WebDoc Content Pane 110 for readers within the Reader Interface 48 will be achieved by clicking on the “WebDoc” control tab within the Reader Control Pane.

The WebDoc Content Pane 110 will display the content of the PaperClick WebDoc as defined by the publisher in the Composer Interface 46, and stored in content storage 42 and/or external web content storage 120. Referring to FIG. 3, each WebDoc will be assigned a title 76 that is unique for the publisher 12. This title 76 will be displayed within the Web browser's title bar 78 for the WebDoc and each content pane associated with the WebDoc.

Referring to FIG. 13, the Reader Interface Links Content Pane 112 will display to the reader a list of Web sites related to the active WebDoc topic. The list of sites will include a description of each site, and a hyperlink to that site. Additionally, a list of search links related to the active WebDoc topic, as well as a link to a Web search engine will be displayed and available for reference.

Navigation to the Links Content Pane 112 for readers will be achieved by clicking on the “Links” control tab within the Reader Control Pane for a specific WebDoc. The Links Content Pane 112 is an optionally installed navigational aid. Publishers may choose to install the “Links” control tab to each of their WebDoc's Reader Control Pane. For installed Links content, each publisher will be responsible for adding their list of link sites (up to ten), including descriptions and URLs, for display in the Links Content Pane 112. Additionally, each publisher will be responsible for adding their list of search sites, including descriptions for display in the Links Content Pane. The publisher will have the opportunity to identify up to five links to “keyword” or “key phrase” searches into a third-party search engine. The system 10 will provide a link to the main entry point in a third-party Web search engine.

If a publisher fails to provide content for their WebDoc's installed Links Content Pane, the system 10 will provide a default page with a link to the main entry point in a third-party Web search engine.

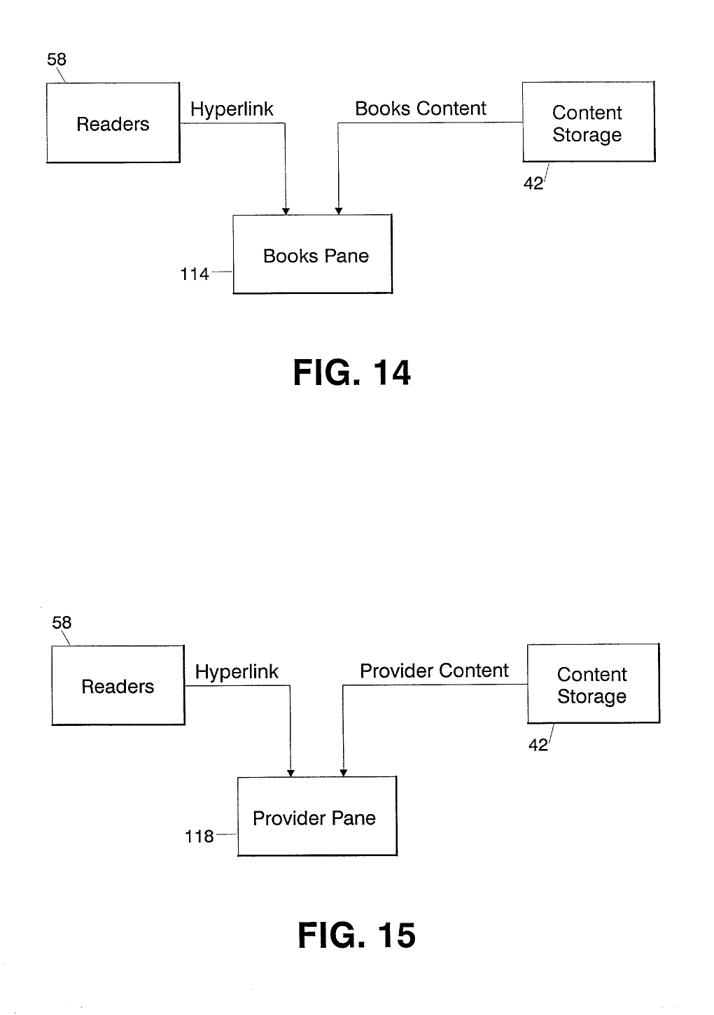

Referring to FIG. 14, the Reader Interface Books Content Pane 114 will display to the reader a list of books related to the active WebDoc topic. The list of books will include descriptions of each book, along with the book's title and may optionally include the book's author. Hyperlinks to specific book titles and authors from an on-line book sales site, as well as a link to a book search engine will be displayed and available for reference.

Navigation to the Books Content Pane 114 for readers will be achieved by clicking on the “Books” control tab within the Reader Control Pane for a specific WebDoc. The Books Content Pane 114 is an optionally installed navigational aid. Publishers may choose to install the “Books” control tab to each of their WebDoc's Reader Control Pane, as shown, for example, in FIG. 3. For installed Books content, each publisher will be responsible for adding their list of book sites (up to ten), including descriptions, titles, and authors, for display in the Book Content Pane. The publisher will have the opportunity to identify up to five links to “keyword” or “subject” searches into a third-party book search engine. The system 10 will provide a link to the main entry point in a third-party book search engine.

If a publisher fails to provide content for their WebDoc's installed Books Content Pane 114, the system 10 will provide a default page with a link to the main entry point in a third-party book search engine.

Referring to FIG. 15, the Reader Interface Provider Content Pane 118 will display to the reader information regarding the publisher of the active WebDoc. Navigation to the Provider Content Pane 118 for readers will be achieved by clicking on the “Provider” control tab within the Reader Control Pane for a specific WebDoc. The Provider Content Pane 118 is an optionally installed informational aid. Publishers may choose to install the “Provider” control tab to each of their WebDoc's Reader Control Pane. For installed Provider content, publishers will be responsible for adding their Provider Content information URL, or contact information. The content of the Provider Pane 118 will be the same for all WebDocs produced by a particular publisher.

Forum Processing

Referring to FIG. 11, a forum pane 116 may also be provide through the reader interface 48 to permit access by readers 58 to forum content stored in forum content storage 122, as described herein, and also providing forum processing 124.

The Composer Interface

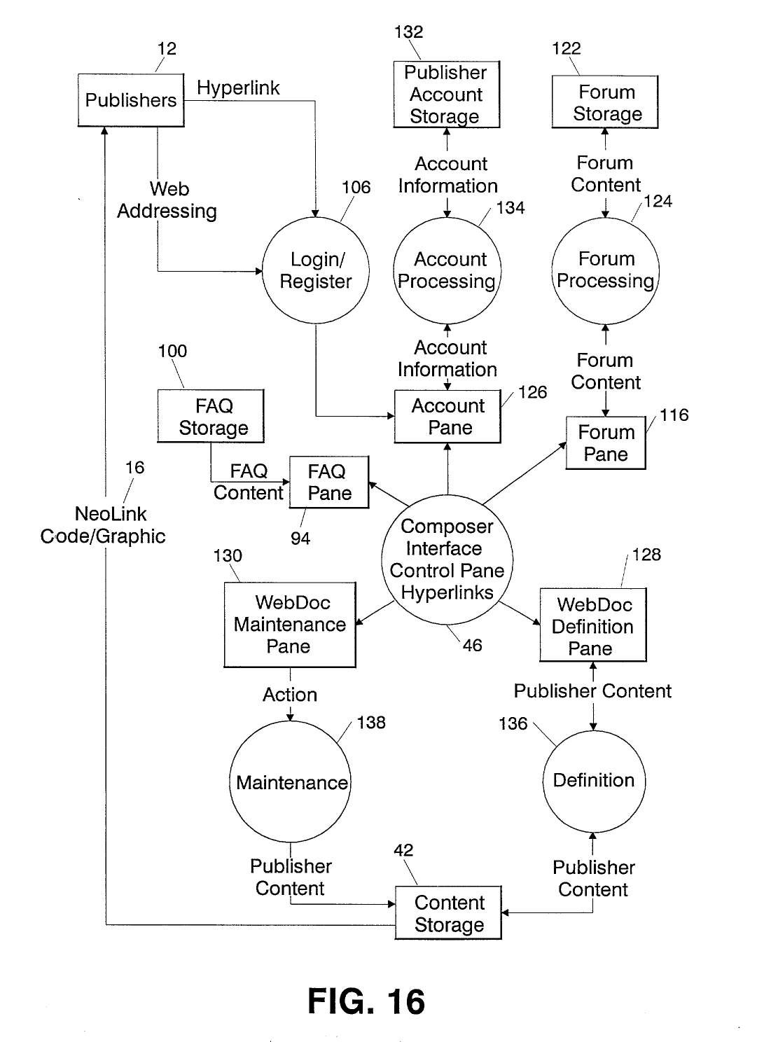

Referring to FIG. 16, the Composer Interface 46 operates to provides a prospective publisher with a mechanism to initiate the PaperClick service. The Composer Interface 46 also allows registered, active PaperClick publishers to define or modify their primary content. Publishers can navigate to the Composer Interface 46 via hyperlink from the PaperClick Home Page or by directly entering the Web address for the Composer Interface (http://www.composer.paperclick.com) into their Web browser. Prior to entry publishers will be prompted to login to the Composer Interface, or register for the PaperClick service. No registered publisher will have editorial access to any page created by another publisher.

The Composer Interface 46 is supported by the system 10 using the Common PaperClick Interface Components to aid the publisher in their navigation (i.e., the Frameset 62, Control Pane 66, and Content Pane 46). Content Panes 64 will be predefined and linked to their respective tab controls within the Composer Control Pane.

The Composer Control Pane will provide links to the following Content Panes:

Account 126—publisher account registration content.

WebDoc Definition 128—WebDoc content definition form.

WebDoc Maintenance 130—WebDoc content maintenance form.

Forum 116—newsgroup style online forums to allow interaction among publishers concerning the WebDoc content definition process.

FAQ 94—Frequently Asked Questions pertaining to the system 10.

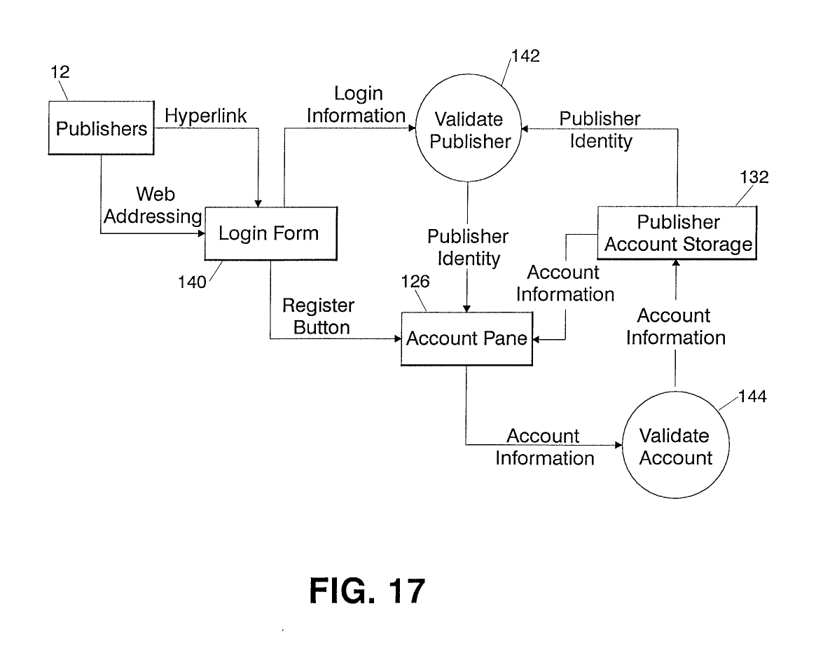

Referring to FIGS. 16 and 17, the Composer Interface Account Content Pane 126 will be displayed to perform account processing 136 with such account information stored in publisher account storage 138. Upon display of the Account Pane 126, a data entry form will be displayed as a login form 140 whereby a perspective publisher may initially register or a registered publisher may modify their registration information, with such publisher login information check using a validation procedure 142, and the account may be further processed for account validation 144. Each publisher will be required to provide a primary contact, with a unique login and password. The Account Content Pane 126 is considered the main page of the Composer Interface. Initial navigation to the Account Content Pane 126 will be achieved via hyperlink from the PaperClick Home Page http://www.paperclick.com, or by directly entering the Web address for the Composer Interface http://www.composer.paperclick.com into a Web browser. Navigation back to the Account Content Pane 126 for publishers within the Composer Interface 46 will be achieved by clicking on the “Account” control tab within the Composer Control Pane.

During initial publisher registration, the publisher will be presented with the Account Content Pane 126; however, the Composer Control Pane will be unavailable. Hence, a publisher will be unable to navigate the Composer Interface 46, and subsequently define their WebDocs, until they have successfully registered. The Account Content Pane 126 is a system-installed data entry form. Upon initial registration, the publisher will be required to define the following publisher information to the system 10: name, address, telephone number, E-mail address, and preferred content definition language. The following optional publisher fields may also be defined: industry, and fax number. Additionally, the publisher will be required to define the following primary contact information to the system 10: unique login ID, password, name, mailing address, telephone number, email address, and preferred correspondence language. The following optional contact fields may also be defined: fax number, job function, and job title. Each of these fields will be defined on the data entry form within the Account Content Pane.

After the publisher has successfully registered with the system 10, they may return to the Account Content Pane 126 to modify their account and primary contact information at any time. A publisher 12 will only have access to their account via their primary contact's login id and password. If a registered publisher loses their primary contact's login id or password, they may request the information via hyperlink to the system 10 Administrator's email address from the Login Pane. For security, the system 10 will only route a new password to the publisher's registered email address.

As part of the publisher account registration, the publishers can elect to supply their own Provider content or have the system 10 generate their Provider content based upon their account information. For publishers wishing to supply their own page of Provider content, they will be required to define the following information to the system 10: unique title, and Provider Content URL.

The system administrator may elect to inactivate a registered publisher. Inactive publishers will have no access to the system 10 other than as readers, however all of their account and content information will be retained and continue to be enabled.

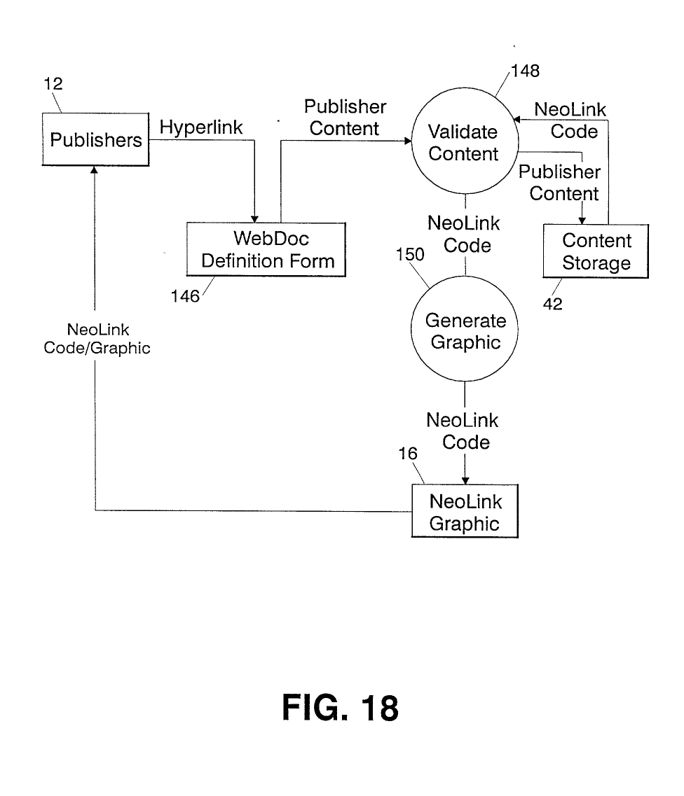

Referring to FIGS. 16 and 18, the Composer Interface WebDoc Definition Content Pane 136 will display a data entry form 146 whereby a publisher may define new Reader Interface WebDoc content, or modify their existing WebDoc content. Navigation to the WebDoc Definition Content Pane for publishers will be achieved by clicking on the “WebDoc Definition” control tab within the Composer Control Pane. The WebDoc Definition Content Pane 136 is a system-installed data entry form.

The form will be broken into several parts that represent the content type being defined/edited. The entered data in the form 146 may be further processed for determining if the submitted publisher content is valid using a validation procedure 148; for example, family-oriented websites may bar sexually explicit publisher content.

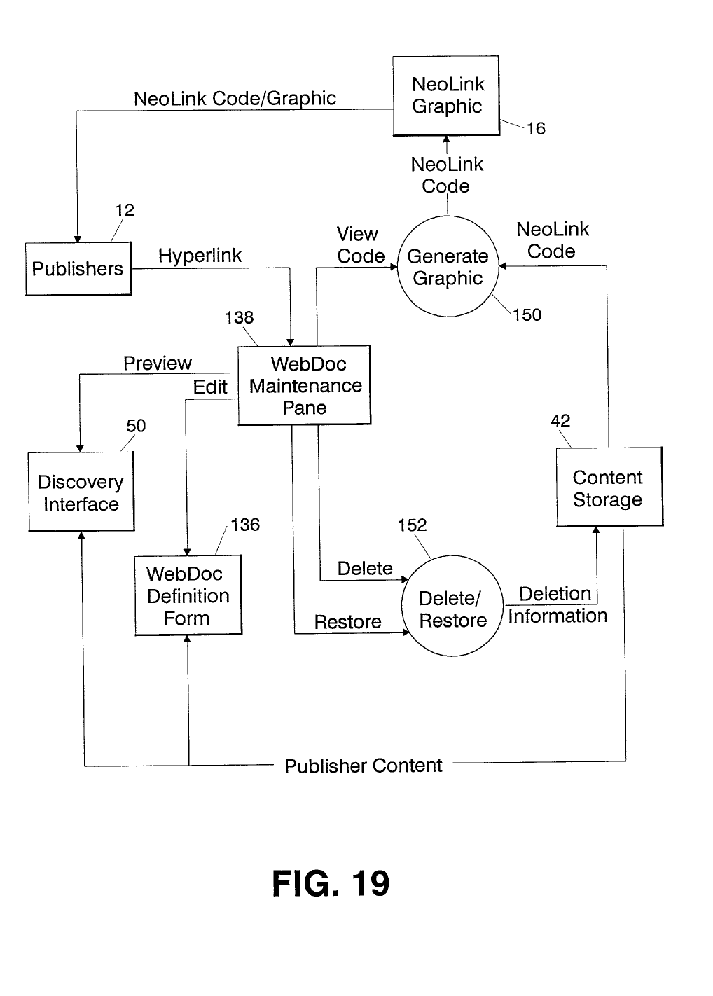

Upon successfully submitting the form and having the content validated, the publisher will be given the opportunity to actuate a graphic generation procedure 150 to generate a graphic in the form of a bar code from a “NEOLINK” code or other data such as unique code generation procedures, such as random numbers without repetition permitted. The generation procedure 150 then permits the publisher 12 to download or output the graphic 16 containing a unique bar code associated with the WebDoc in a variety of graphic formats and sizes. The publisher 12 may modify their WebDoc content at any time through the WebDoc Maintenance Content Pane 138 described herein with reference to FIG. 19.

The WebDoc Definition data entry form 146 will be divided into sections representing a pane to be defined/edited. For optional panes, the system 10 may enable or disable the corresponding section of the form, in order to provide publishers with only relevant pane choices. From this information, the bar code 16 is generated by the system 10, and the generated bar code and its associated content are linked by the system 10.

A publisher wishing to associate a bar code with specific, external web content will be required to define the following information to the system 10 prior to the activation of the WebDoc: unique title, description, category, keywords, and WebDoc Content external URL. WebDoc titles must be unique for each publisher.

A publisher must declare or change the activation state of their WebDoc content, using the following options: disabled, enabled, enabled upon a publisher-specified date. Whenever a WebDoc is disabled, the system 10 will create a default Web page for display in the Reader Interface, or the publisher may create their own disabled page and enter its URL as the “WebDoc Disabled Page URL”. If an activated WebDoc is deactivated, the defined content will remain within the system 10 for a preset period of time. Until the retention period has expired, the WebDoc content will be available for retrieval and subsequent activation. After the retention period has expired, the system 10 will automatically remove the WebDoc and its related content.

Referring to FIGS. 16 and 19, the Composer Interface WebDoc Maintenance Content Pane 138 will display a list of a publisher's defined WebDocs, to allow a publisher 12 to modify, delete, and/or restore associations between content, hyperlinks, and bar codes. Through the Maintenance Pane 138, the publisher 12 may edit content and/or bar codes for content 22 in conjunction with the WebDoc Definition Form 136; may preview content and/or associated bar codes and hyperlinks through the Discovery Interface 50; may generate and view codes through the graphic generation procedure 150; and may modify such bar codes and related information though a delete/restore procedure 152, to perform such functions on a selected WebDoc. The list of possible functions includes “Preview”, “Edit”, “Delete”, “Restore”, and “View Code”. Navigation to the WebDoc Maintenance Content Pane 138 for publishers will be achieved by clicking on the “WebDoc Maintenance” control tab within the Composer Control Pane. The WebDoc Maintenance Content Pane 138 is a system-installed table. The WebDoc Maintenance Content Pane will display a list of a publisher's defined WebDocs, along with a “creation date”, “last modification date”, and “status” for each. If the WebDoc has been marked for deletion, the “deletion date” will also be displayed.

For each listed WebDoc, a publisher may preview their inactive WebDoc by depressing the “Preview” button. By doing so, they will be transferred to the Reader Interface, where their WebDoc and related content will be displayed. From the Reader Control Pane, a tab titled “Exit” will be appended to the tab folder, which will return a publisher to the Composer Interface.

For each listed WebDoc, a publisher may edit their WebDoc by depressing the “Edit” button. By doing so, they will be transferred to the WebDoc definition form, with all of their WebDoc data already defined.

For each listed WebDoc, a publisher may delete their WebDoc via the “Delete” button. Depressing the “Delete” button will schedule a particular WebDoc for deletion. By doing so, the WebDoc and all related content will be removed from the system 10 after being on the deletion schedule for thirty (30) days. Whenever a WebDoc is scheduled for deletion, the “Delete” button is replaced with the “Restore” button.

For each listed WebDoc scheduled for deletion, a publisher may restore the WebDoc by depression the “Restore” button. By doing so, the WebDoc and all related content will be removed from the deletion schedule. Whenever a WebDoc is removed from the deletion schedule, the “Restore” button is replaced with the “Delete” button.

The delete/restore procedure 152 permits the publisher to remove an association with a bar code and/or a hyperlink from specified content in the content storage 42. However, the publisher 12 may optionally restore a previously deleted bar code or hyperlink, to avoid accidental deletions and breaks in associations between content, bar codes, and hyperlinks; for example, during routine maintenance of the content of the publisher.

For each listed WebDoc, a publisher may display the system 10 generated a Portal bar code by depressing the “View Code” button. The publisher will be given the opportunity to generate, download, and/or output the graphic containing the unique code associated with the content in a variety of graphic formats and sizes.

Types Of Content

The disclosed online media linking system 10 and method of use permit publishers 12 to link content 22 with hyperlinks/URLs 20 and to bar codes 16. In addition, publishers 12 may associate diverse content together through diverse and/or specialized panes in the framesets 62 of WebDocs.

Panes having sets of inks to other content throughout the Internet 14 may also be provided, for example, through an optional Web page of content related to a particular WebDoc available to readers through the Reader Interface 48. By default, the system 10 will install Links content for a WebDoc. A publisher may elect to forgo the display of associated Links content for their WebDocs by deselecting the “Install Links Content” checkbox. After defining Links content, the publisher may disable the page at any time without losing their defined Links content.

For installed Links content, the publisher may define a list of link sites related to their specific WebDoc. They may include up to ten (10) related link sites per WebDoc. For each related link, a publisher will be required to define the following information to the system 10: title, description, and the related site's URL.

Additionally, the publisher may define a list of search link sites related to their specific WebDoc. They may include up to five (5) related search link sites per WebDoc. For each related link, a publisher will be required to define the following information to the system 10: title, description and search keyword(s).

If a publisher fails to provide content for their WebDoc's installed Links Content Pane, the system 10 will provide a default page with a link to the main entry point in a third-party Web search engine.

Books content is an optional Web page of content related to a particular WebDoc available to readers through the Reader Interface. By default, the system 10 will not install Books content for a WebDoc. A publisher may elect to display their associated Books content for their WebDocs by selecting the “Install Books Content” checkbox. After defining Books content, the publisher may disable the page at any time without losing their defined Books content.

For installed Books content, the publisher may define a list of books related to their specific WebDoc. They may include up to ten (10) related book sites per WebDoc. For each related book, a publisher will be required to define the following information to the system 10: book's title, and description. The following optional information may be defined for each related book: author.

Additionally, the publisher may define a list of book search sites related to their specific WebDoc. The publisher may include, for example, five related book search sites per WebDoc. For each related link, a publisher will be required to define the following information to the system 10: title, description and search keyword/author/subject. If a publisher fails to provide content for their WebDoc's installed Books Content Pane, the system 10 will provide a default page with a link to the main entry point in a third-party book search engine.

Forum content is an optional Web page of content related to a particular WebDoc available to readers through the Reader Interface. By default, the system 10 will not install Forum content for a WebDoc. A publisher may elect to display their associated Forum content for their WebDocs by selecting the “Install Forum Content” checkbox. After defining Forum content, the publisher may disable the page at any time without losing their defined Forum content, or the posted messages within the forum.

By default, publishers will be assigned a single feedback forum, to which all their Forum Content Panes will be mapped. A publisher may have more than one feedback forum, and may choose the feedback forum with which an installed Forum Content Pane will be associated. For installed Forum content, the publisher may create or remove topic groups within a particular forum. Each publisher will have administrator access to their forum(s), and, as such, will have the ability to delete individual posts within a topic group.

Provider content is an optional Web page of content related to a particular WebDoc available to readers through the Reader Interface. By default, the system 10 will install Provider content for a WebDoc. A publisher may elect to forgo the display of their Provider content for their WebDocs by deselecting the “Install Provider Content” checkbox.

What is claimed is:

1. A system for accessing content on a network, the system comprising:
a publisher interface, responsive to publisher inputs, for generating a code associated with a web-based document including the content;
a user interface for receiving the code inputted by the user to access the corresponding content selected by the user; and
a web server, responsive to the inputted code, for providing the web-based document including the selected content.

2. The system of claim 1, further comprising:
a content storage device for storing the web-based document generated by a publisher associated with the code and retrievable by the web server.

3. The system of claim 1, further comprising:
a composer interface, responsive to selections by the publisher, for generating the web-based document including publisher content, and for associating the generated code with the web-based document.

4. The system of claim 1, further comprising:
a code scanner, operated by a user, for scanning the code, and for generating a corresponding code signal;
wherein the web server, responsive to the code signal as the inputted code, provides to the user the web-document associated with the scanned code.

5. The system of claim 4, wherein the code is a graphic capable of being read by the code scanner.

6. The system of claim 5, wherein the graphic is printable by a publisher to be placed on a physical document provided to the user.

7. The system of claim 5, wherein the graphic includes a bar code; and
wherein the code scanner is a bar code reader for scanning the graphic, including the bar code.

8. The system of claim 1, wherein the web-based document includes a plurality of panes as sub-pages of the web-based document.

9. The system of claim 8, wherein each of the plurality of panes corresponds to respective sets of publisher-specified content.

10. A system for accessing content over the Internet, the system comprising:
a publisher interface, responsive to publisher inputs, for generating a graphic, including a bar code, associated with a web-based document including the content, and for outputting the graphic with the bar code onto a physical document;
a user interface, connected to the Internet, for receiving from the user the graphic with the bar code on the physical document to access the corresponding content selected by the user; and
a web server, connected to the Internet, for storing the web-based document, responsive to the inputted graphic with the bar code, for providing to the user, through the user interface, the web-based document including the selected content.

11. The system of claim 10, wherein the web server includes:
a content storage device for storing the web-based document generated by a publisher associated with the graphic and retrievable by the web server.

12. The system of claim 10, further comprising:
a composer interface, responsive to selections by the publisher, for generating the web-based document including publisher content, and for associating the generated graphic with the web-based document.

13. The system of claim 10, further comprising:
a bar code scanner, operated by a user, for scanning the graphic with the bar code, and for generating a corresponding code signal;
wherein the web server, responsive to the code signal as the inputted bar code, provides to the user the web-document associated with the scanned bar code.

14. The system of claim 13, wherein the graphic is printable by a publisher to be placed on a physical document provided to the user for scanning by the bar code scanner.

15. The system of claim 10, wherein the web-based document includes a plurality of panes as sub-pages of the web-based document.

16. The system of claim 15, wherein each of the plurality of panes corresponds to respective sets of publisher-specified content.

17. A method for accessing content on a network, the method comprising the steps of:
storing the content in a web-based document on a web server;
generating, in response to publisher inputs through a publisher interface, a graphic including a bar code, with the graphic being associated with the content;
outputting the graphic with the bar code onto a physical document;
receiving, at a user interface, the graphic with the bar code on the physical document;
responding to the inputted graphic with the bar code at a web server; and
retrieving the stored the web-based document including the selected content corresponding to the inputted graphic.

18. The method of claim 17, further comprising the steps of:
receiving as a composer interface, to selections by the publisher;
generating the web-based document including publisher content; and
associating the generated graphic with the web-based document.

19. The method of claim 17, wherein the step of receiving includes the step of:
scanning the graphic with the bar code using a bar code scanner, operated by a user;
wherein the step of responding to the inputted graphic includes the steps of:
generating a code signal corresponding to the scanned graphic; and
responding to the code signal as the inputted bar code to provide to the user the web-document associated with the scanned bar code.

20. The method of claim 17, wherein the step of outputting includes the steps of:
printing the graphic as a printed document; and
placing the printed graphic onto a physical document to be provided to the user for inputting to receive the content.
